(19) United States
(12) Patent Application Publication
(10) Pub. No.: US 2024/0129104 A1
(43) Pub. Date: Apr. 18, 2024

(54) GENERIC SYNTHESIZABLE CIRCUIT COUNTERMEASURE AGAINST HARDWARE SCA

(71) Applicant: Intel Corporation, Santa Clara, CA (US)

(72) Inventors: Jason M. Fung, Portland, OR (US); Debayan Das, Hillsboro, OR (US); Sayak Ray, San Jose, CA (US); Rana Elnaggar, San Jose, CA (US); Majid Sabbagh, Santa Clara, CA (US)

(21) Appl. No.: 17/964,549

(22) Filed: Oct. 12, 2022

(51) Int. Cl. H04L 9/00

(52) U.S. Cl. CPC H04L 9/003

(57) ABSTRACT

An apparatus, system, and method for protecting a component from an observation attack are provided. A power balancing circuit configured to protect a cryptography component can include a ring oscillator electrically connected to a power supply, a time-to-digital converter (TDC) electrically connected to monitor an electrical parameter of the electrical power drawn by the cryptography component and provide data indicative of the electrical parameter, and a controller circuit configured to adjust a number of inverters of the ring oscillator drawing power from the power supply based on the data.

### TECHNICAL FIELD

Embodiments pertain to circuitry that protects against side-channel attacks (SCAs).

### BACKGROUND

Hardware side-channel analysis (SCA) attacks like differential power analysis (DPA) can break computationally secure crypto algorithms within a few minutes. These attacks are becoming an increasing threat with the availability of low-cost equipment. SCAs pose a serious threat to hardware products that use cryptographic hardware. Previous SCA countermeasures include masking, randomized projective coordinates, supply isolation and signature attenuation circuits, noise injection, or wave dynamic differential logic (WDDL) for power balancing. These existing DPA protection techniques are either algorithm specific (not generic), require at least 2× silicon area and power overheads (high cost) as compared to just the cryptographic hardware, or are not synthesizable (unsuitable for field programmable gate arrays (FPGAs)). Moreover, the existing DPA protection techniques lead to performance degradation (reduction in throughput) of the baseline crypto implementation and are not scalable across different crypto implementations currently existing in cryptographic hardware products. Masking is algorithm-specific, requires crypto expertise as masking requires changes to the algorithm itself, and doubles the power consumption/area as compared to the circuit being protected without masking. Randomized projective coordinate is specifically used to protect elliptic curve cryptography (ECC) operations. WDDL requires new library cell design and about doubles area/power overhead as compared to a circuit without WDDL. Signature attenuation circuits are low-overhead and generic but are not synthesizable, which is a requirement for FPGA-based implementation. Noise injection circuits can be generic and synthesizable, but they incur about ten times more power and area overhead as compared to the circuit without protection. Most of the countermeasures have high area and power overheads which are not practical for high throughput crypto implementations that consume significant silicon-area even without any SCA protection. For example, an implementation of AES-128 includes 250,000 logic cells which is increased to about 500,000 if one were to implement the masking technique to protect the AES-128.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 illustrates, by way of example, a circuit diagram of an embodiment of a device that includes observation attack protection for a component.

FIG. 2 illustrates, by way of example, a flow diagram of a method for intermittent component operation.

FIG. 3 illustrates, by way of example, a graph of current versus time for the conductor (iₛᵤₚ), the power balancing circuit (i_{bc}), and the component (i_{c}).

FIG. 4 illustrates, by way of example, a circuit diagram of an embodiment of a system that includes multiple power balancing circuits protecting multiple respective components.

FIG. 5 illustrates, by way of example, a diagram of an embodiment describing optimal placement of the power balancing circuit.

FIG. 6 illustrates, by way of example, a block diagram of an embodiment of a machine (e.g., a computer system) that includes components that can be protected by the power balancing circuit.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments provide a generic and low-overhead (area/power) physical/circuit-level countermeasure to prevent side channel attacks (SCAs). Embodiments are synthesizable and thus can be implemented on field programmable gate arrays (FPGAs) as well as application specific integrated circuits (ASICs). The SCA countermeasure of embodiments can be applied as a wrapper across any security-sensitive designs like artificial intelligence (AI)/machine learning (ML) accelerators as well as the conventional crypto cores. The embodiments provide protection against SCA as well as power observation, electromagnetic (EM) observation, and other related observation methods. Embodiments thus improve security of circuitry. The circuitry is often available on an FPGA or an ASIC, so the circuitry of embodiments is synthesizable so that it can be included on the FPGA or ASIC.

Devices use various crypto algorithms including Advanced Encryption Standard (AES), ECC, Secure Hach Algorithm (SHA)-2 (SHA2), SHA3, ShangMi (SM) 2 (SM2), SM3, SM4, Elliptic Curve Digital Signature Algorithm (ECDSA), Elliptic Curve Diffie-Helman (ECDH), or Rivest-Shamir-Adleman (RSA), among others. Therefore, algorithm specific differential SCA protection approach incurs high design, implementation, and validation costs.

Embodiments use time-to-digital converter (TDC) and a bank of ring oscillators (ROs). The TDC senses the crypto (or any security-sensitive design in general) current fluctuations locally. Data indicating a magnitude of the fluctuations are fed to a digital controller that turns on or off the required number of ring oscillator (RO) stages (bleed) depending on the instantaneous current. Hence, when the security-sensitive block/crypto engine consumes less current, more ROs are turned on to bleed extra current from the supply; while when the security-sensitive/crypto core draws high current, less ROs are enabled by the digital loop so that the overall supply current remains almost constant. The unchanging supply current yields SCA and other observation-based attacks fruitless as such attacks rely on detecting changes in the supply current to be successful.

The countermeasure can be applied as a wrapper across any security-sensitive designs like AI/ML accelerators as well as the conventional crypto cores. Embodiments have been implemented on an FPGA and demonstrate a signal-to-noise-ratio (SNR) reduction of greater than 100× from an AES-128 crypto engine. This means that the synthesizable circuit can provide a greater than 10,000 times more protection against differential power, EM and related SCA attacks as compared to an unprotected security-sensitive circuit.

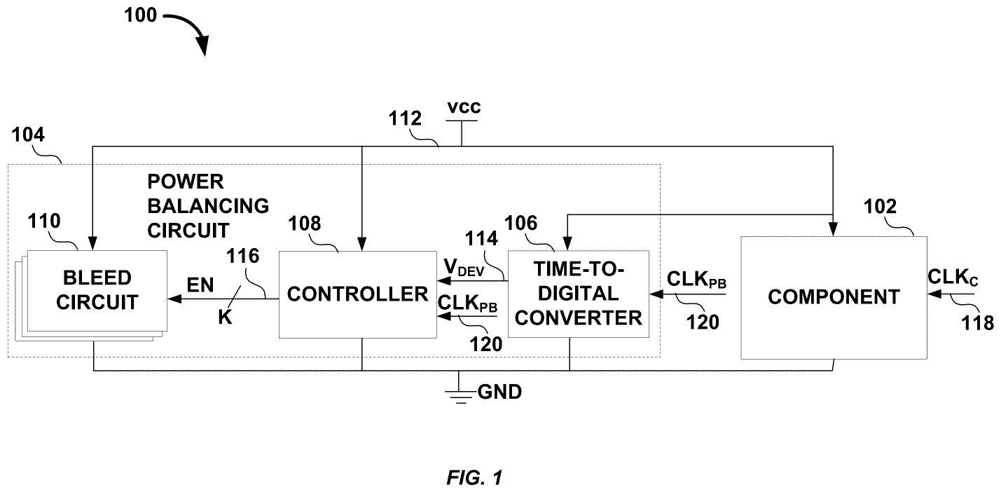

FIG. 1 illustrates, by way of example, a circuit diagram of an embodiment of a device 100 that includes observation attack protection for a component 102. The device 100 as illustrated includes the component to be protected. The device 100 further includes a power balancing circuit 104 that protects the component 102 from the observation attack. The power balancing circuit 104 monitors an electrical parameter (e.g., power, current, voltage, frequency, magnitude, amplitude, or the like) of electrical power drawn by the component 102. The power balancing circuit 104 includes a time-to-digital converter (TDC) 106, a controller 108, and a bleed circuit 110. The TDC 106 is electrically and communicatively coupled between the component 102 and the controller 108. The controller 108 is electrically and communicatively coupled between the TDC 106 and the bleed circuit 110.

The device 100 can include an FPGA, ASIC, or other device that can implement the power balancing circuit 104. Since the power balancing circuit 104 is synthesizable. Synthesizable means that a hardware version of the circuit can be generated given the constraints of the FPGA or ASIC. In the example of the FPGA, a synthesizable circuit is one that can be implemented using one or more clocks, multiplexers, registers, logic gates (e.g., AND, OR, XOR, negate, buffer, or the like), switches, or another FPGA component.

The component 102 includes a combination of electric or electronic components that can be subjected to an observation attack. Components that perform cryptography operations, such as on an FPGA or ASIC, are often targeted in observation attacks, but other components can be targeted as well.

Electric or electronic components include resistors, transistors, capacitors, inductors, diodes, amplifiers, memory devices, power supplies, switches, analog to digital converters, digital to analog converters, multiplexers, logic gates, transducers, transformers, buck or boost converters, processing circuitry (e.g., a CPU, FPGA, graphics processing unit (GPU), ASIC, or the like), among others.

The power balancing circuit 104 receives an input that is the power drawn by the component 102. The power drawn by the component 102 on a power conductor 112, in the absence of the power balancing circuit 104, fluctuates as it performs operations. The fluctuations in the power on the conductor 112 can be analyzed to determine a cryptographic key or other sensitive information being processed or used by the component 102. This sort of analysis is sometimes called an observation attack or an SCA. To combat this sort of attack, the power balancing circuit 104 adjusts a power drawn from on the conductor 112 so that the power drawn by the component 102 is uncorrelated with the power on the conductor 112. The power balancing circuit 104 adjusts the power drawn by enabling and disabling a number of active components in a bleed circuit 110 based on the power drawn by the component 102.

The TDC 106 determines a time between start and stop pulses on the conductor 112. A start pulse occurs when the voltage on the conductor rises above a specified threshold. A stop pulse occurs when the voltage on the conductor 112 falls below the specified threshold. The TDC 106 can provide data 114 to the controller 108 indicating whether the voltage is above or below the specified threshold. Note the TDC can have multiple thresholds and the data 114 can indicate whether the voltage on the conductor 112 is above or below any of the specified thresholds.

The TDC 106 senses the voltage, current, power or a combination thereof on the conductor 112. The TDC 106 can be physically placed as close as possible to the component 102. The TDC 106 senses the propagation delay owing to the instantaneous voltage fluctuations due to the current consumption of the component 102. The TDC 106 then converts the sensed voltage droop to digital bits. The TDC 106 provides the sensed voltage droop to the controller 108. The controller 108 decides how many bleed circuits 110 (also locally placed) are enabled at any given time.

The controller 108 can receive the data 114 from the TDC 106 and enable, using respective enable signals 116, a number of the bleed circuits 110 based on the received data 114. The number of bleed circuits 110 enabled can be greater if the data 114 indicates the power draw on the conductor 112 is low as compared to the number of bleed circuits 110 enabled if the data 114 indicates the power draw on the conductor 112 is high. The controller 108 can include or otherwise have access to a look up table (LUT) that maps the data 114 to the number of bleed circuits 110 that are enabled. The controller 108 can use a heuristic (e.g., a rule or formula or the like) to determine the number of bleed circuits 110 to enable based on the data 114. In general, one can determine how much power is drawn by each of the bleed circuits 110 and can activate one or more bleed circuits 110 such that a desired power drawn equals the power drawn by the component 102 plus the power drawn by the activated bleed circuits 110. The controller 108 can be implemented using logic gates, or other synthesizable electrical or electronic components.

The bleed circuits 110 can include series connected negate gates (e.g., a ring oscillator). The bleed circuits 110 can be digitally controllable by the enable signal 116. If an enable signal for a bleed circuit 110 is high, then the bleed circuit 110 can conduct electricity, and if the enable signal for the bleed circuit 110 is low, then the bleed circuit 110 cannot conduct electricity. Note that negative logic is also possible.

The component 102 can operate using a first clock signal 118. The PBC 104 can operate using a second clock signal 120 that is the same or different frequency as the first clock signal 118. The clock signal 120 can have a frequency that is greater than the frequency of the clock signal 118 (e.g., 1.1×, 1.5×, 2×, 2.5×, 5×, greater than the frequency of the clock signal 118, a greater frequency, or a frequency therebetween). This higher frequency for the clock signal 120 can help the power balancing circuit 104 compensate for any instantaneous current fluctuations (current fluctuations faster than the frequency of the clock signal 118) of the component 102.

The device 100 provides a low-cost solution to prevent hardware observation attacks, such as on security-sensitive implementations. The proposed countermeasure circuit is fully digital and synthesizable. Thus, the device 100 can be easily integrated on an FPGA, ASIC, or other hardware circuit. The device 100 has very low area/power overheads (<1.5× compared to the component 102 without security) compared to any of the countermeasures developed till date and it does not incur any performance penalty. Therefore, the device 100 can provide advanced side-channel protected components 102. The device 100 will also be of interest to our competitors trying to provide side-channel protection for any security-sensitive/crypto algorithms without any change to the existing legacy implementations. When the component 102 draws more current (more voltage droop), fewer bleed circuits 110 can be enabled to draw power, while when the instantaneous component 102 current is lower (less voltage droop), more bleed circuits 110 can be enabled, so as to help ensure that the supply current is equalized and is almost completely uncorrelated with the component 102 current. The TDC 106 combined with the controller 108 uses the bleed circuits 110 to bleed any excess current thereby compensating for the component 102 current consumption instantaneously, thus providing global negative feedback. Hence, the supply current (power traces) obtained through the supply pin (accessible to an attacker) remains independent of the component 102 current fluctuations, thereby providing strong resistance against hardware SCA and other observation-based attacks. The power balancing circuit 104 can be enabled intermittently based on when the component 102 is enabled, thereby saving power consumption, and reducing the overheads.

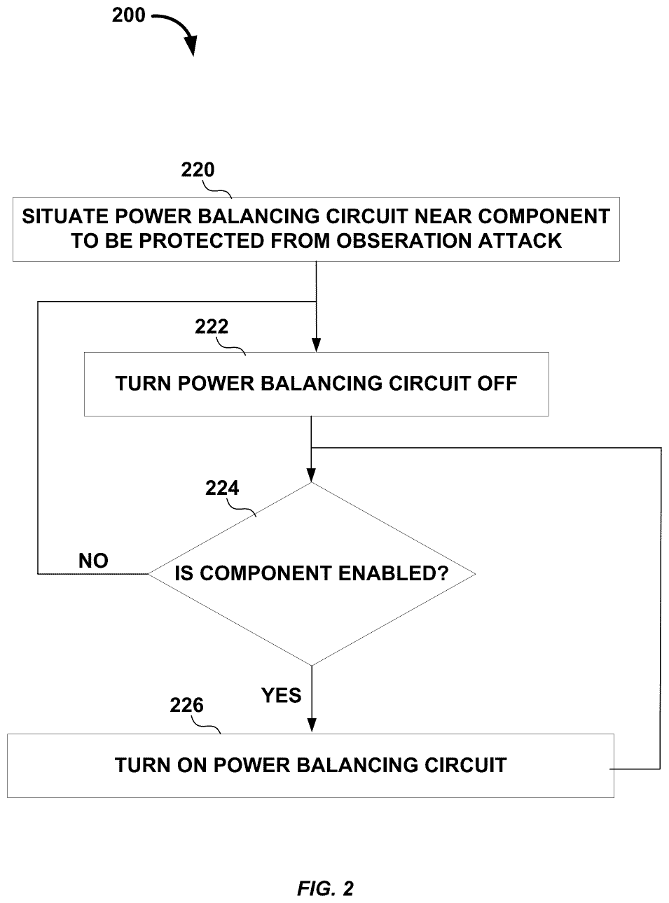

FIG. 2 illustrates, by way of example, a flow diagram of a method 200 for intermittent component 102 operation. The method 200 as illustrated includes situating the power balancing circuit 104 near the component 102, at operation 220. The component 102 is to be protected from the observation attack. At operation 222, the power balancing circuit 104 default to a powered off state. Then, at operation 224 it can be determined whether the component is enabled (drawing power above a specified threshold). If the component is not enabled, the power balancing circuit 104 can remain turned off or be turned off if it is currently drawing power. This is because the power balancing circuit 104 has no operating circuit to protect if the component 102 is not drawing power. If the component 102 is enabled, the power balancing circuit 104 can be turned on at operation 226, such as to protect the component 102 from an observation attack. The operation 224 can then be performed again. The operation 224 can be performed periodically, responsive to sensing an increase in power drawn by the component 102, responsive to a switch closing, or the like.

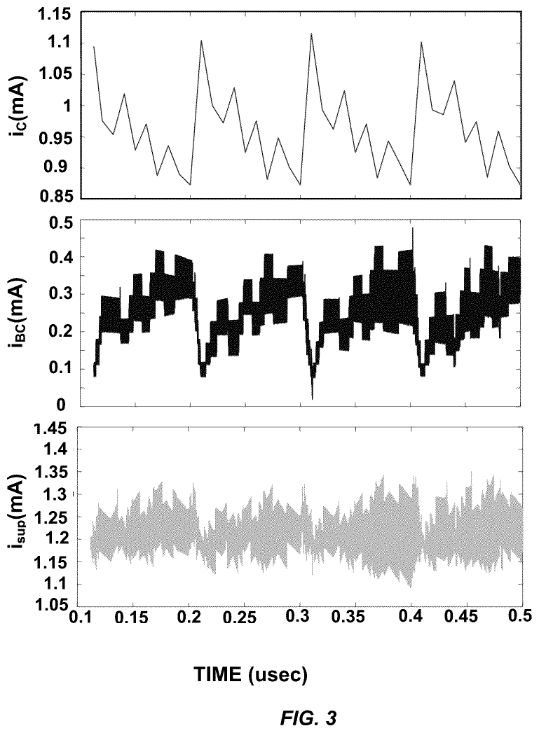

FIG. 3 illustrates, by way of example, a graph of current versus time for the conductor 112 (iₛᵤₚ), the power balancing circuit 104 (i_{bc}), and the component 102 (i_{c}). As can be seen iₛᵤₚ is uncorrelated with i_{c} making it difficult, if not impossible, to determine data used by the component 102 based on observing an electrical parameter on the conductor 112. The current drawn by the power balancing circuit 104 is inversely correlated with the current drawn by the component 102. This is expected since the number of bleed circuits 110 enabled is inversely proportional to the current drawn by the component 102.

It can be seen that the current fluctuations observed at the supply node (iₛᵤₚ) is highly uncorrelated with the current consumption (i_{C}) of the component 102, as the current from the bleed circuits 110 (i_{BC}) provides the necessary power balancing by drawing opposite current of the component 102, thereby leading to a >100×SNR reduction. With embodiments, the amount of protection is expected to be enhanced in the order of (100)² times greater than other solutions, since the minimum traces to disclosure (MTD) which is the number of traces required to break the component 102 implementation is inversely proportional to SNR 2.

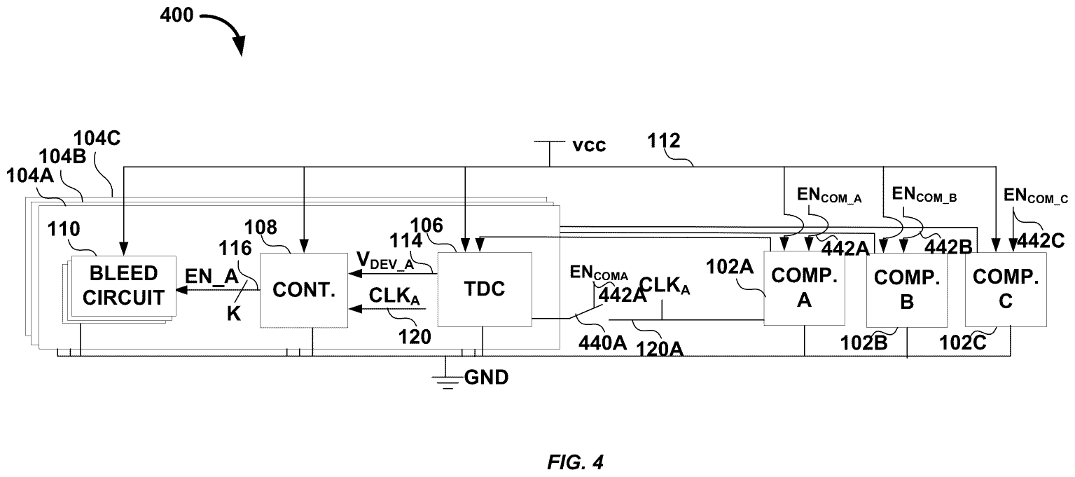

FIG. 4 illustrates, by way of example, a circuit diagram of an embodiment of a system 400 that includes multiple power balancing circuits 104A, 104B, 104C protecting multiple respective components 102A, 102B, 102C. The power balancing circuit 104 is component 102 agnostic and can be scaled across multiple security sensitive/crypto circuits 102A-102C like AES-128, SHA-3, ECC. The controllable switches 440A (other switches not illustrated but can be electrically connected between a clock for the component 102B, 102C and the TDC of the respective power balancing circuit 104B, 104C) for the respective component clocks 120A are set in conjunction with an enable signal 442A, 442B, 442C of the respective component 102A, 102B, 102C. The enable signal 442A, 442B, 442C controls a state of the switch 440A (and other respective switches). When components 102A-102C are enabled at the same time, corresponding countermeasure circuits 104A, 104B, 104C will be automatically activated, and will provide the observation attack protection. For example, if the component 102A and the component 102C are turned on simultaneously at any given instant, the enable signal 442A and the corresponding enable signal for the component 102C will be high, which will enable the clocks 120A (and another clock for the countermeasure circuit 104C) for the countermeasure circuits 104A, 104C. Based on the current of each individual component 102A-102C, each countermeasure circuit 104A-104C will compensate with an independent number of bleed circuits 110 enabled at any given time, thereby ensuring that the supply current remains independent of the individual component 102A-102C.

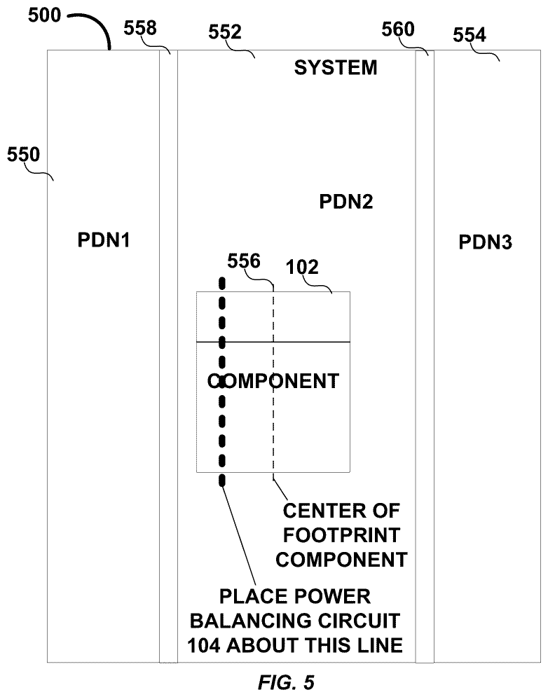

FIG. 5 illustrates, by way of example, a diagram of an embodiment of a system 500. FIG. 5 helps describes optimal placement of the power balancing circuit 104. The power balancing circuit 104 are placed optimally in between the center of the component 102 (represented by line 556 and the nearest power delivery network (PDN) 550, 552, 554 boundary. Trivially, the center of the component 102 (represented by line 556) would provide the highest sensitivity to voltage changes, however the effect of the PDN 550, 552, 554 from which the component 102 receives power, also determines the optimal placement of the power balancing circuit 104 for maximum sensitivity to voltage fluctuations. Boundaries (represented by 558, 560) of the PDN 550, 552, 554 provide good sensitivity as the amount of decoupling capacitance at the boundary 558, 560 is minimum and the voltage droop detected is maximum.

The PDN consists of all the interconnects in the power supply path from the voltage regulator modules (VRMs) to the circuits on the die. Generally, these include the power and ground planes in the boards, cables, connectors, and all the capacitors associated with the power supply. The boundaries 558, 560 of the PDN 550, 552, 554. The PDN 550, 552, 554 is a mesh of supply and ground wires, and the placement is known to the designer when the system 500 fabric layout is being designed. The global PDN may be divided into multiple sub-PDNs 550, 552, 554, each of which is connected to the local cells (lookup tables (LUTs), digital signal processors (DSPs), block random access memory (BRAM), or the like) on the system 500 fabric. The PDN boundaries 558, 560 are known to the infrastructure provider and the electronic design automation (EDA) tool can utilize this information aiding optimal TDC placement for maximum voltage sensing.

Thus, there exists one or more optimal locations between the center of the component 102 and the closest PDN 550, 552, 554 boundary 558, 560 where the power balancing circuit 104 can provide the maximum sensitivity. FIG. 5 shows a system that is sub-divided into three local PDNs 550, 552, 554, however, more or fewer PDNs can be used. This strategy of the optimal power balancing circuit 104 placement holds for other systems as well. The power balancing circuit 104 can be placed optimally at about halfway between the center of the core and the closest PDN boundary, as depicted in FIG. 5. About halfway means within 5% of a midline between a centerline of the footprint of the component 102 and the boundary 558, 560.

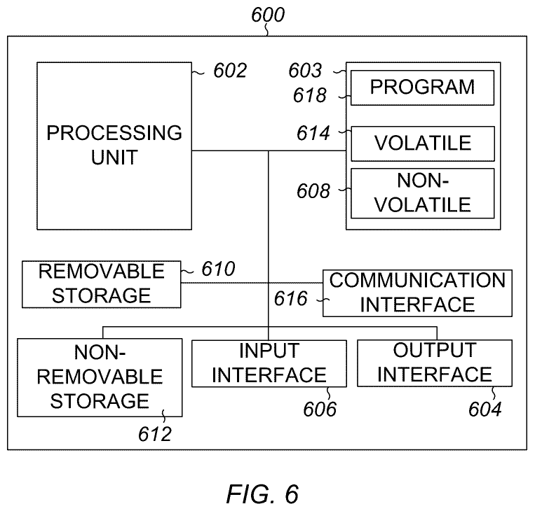

FIG. 6 illustrates, by way of example, a block diagram of an embodiment of a machine 600 (e.g., a computer system) that includes components that can be protected by the power balancing circuit 104. One example machine 600 (in the form of a computer), may include a processing unit 602, memory 603, removable storage 610, and non-removable storage 612. Although the example computing device is illustrated and described as machine 600, the computing device may be in different forms in different embodiments. Further, although the various data storage elements are illustrated as part of the machine 600, the storage may also or alternatively include cloud-based storage accessible via a network, such as the Internet.

Memory 603 may include volatile memory 614 and non-volatile memory 608. The machine 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 600 may include or have access to a computing environment that includes input 606, output 604, and a communication connection 616. Output 604 may include a display device, such as a touchscreen, that also may serve as an input device. The input 506 may include one or more of a touchscreen, touchpad, mouse, keyboard, camera, one or more device-specific buttons, one or more sensors integrated within or coupled via wired or wireless data connections to the machine 500, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 602 (sometimes called processing circuitry) of the machine 600. A hard drive, CD-ROM, and RAM are some examples of articles including a non-transitory computer-readable medium such as a storage device. For example, a computer program 518 may be used to cause processing unit 602 to perform one or more methods or algorithms described herein.

Note that the term “circuitry” or “circuit” as used herein refers to, is part of, or includes hardware components, such as transistors, resistors, capacitors, diodes, inductors, amplifiers, oscillators, switches, multiplexers, logic gates (e.g., AND, OR, XOR), power supplies, memories, or the like, such as can be configured in an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” or “circuit” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry”, “processing circuitry”, or “processor” as used herein thus refers to, is part of, or includes circuitry capable of sequentially and automatically carrying out a sequence of arithmetic or logical operations, or recording, storing, and/or transferring digital data. These terms may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Reference numbers with letter suffixes represent specific instances of a more general component represented by a reference number without a letter suffix. For example, component 102A is a specific instance of the general component 102.

### ADDITIONAL NOTES AND EXAMPLES

Example 1 includes a system for observation attack protection, the system comprising a conductor electrically coupled to a power supply, a component electrically connected to the conductor to receive electrical power from the power supply, and a power balancing circuit including a bank of bleed circuits, the power balancing circuit electrically connected to monitor an electrical parameter of the electrical power drawn by the component and adjust a number of the bleed circuits drawing power from the power supply based on the electrical parameter.

In Example 2, Example 1 further includes, wherein the component is configured to perform cryptography operations.

In Example 3, at least one of Examples 1-2 further includes, wherein the power balancing circuit includes a time-to-digital converter configured to provide data indicating a change in the electrical parameter.

In Example 4, Example 3 further includes, wherein the power balancing circuit includes a controller circuit configured to review the data and set respective enable signals of the bleed circuits based on the data.

In Example 5, at least one of Example 1-4 further includes a switch electrically connected between the power balancing circuit and the component.

In Example 6, Example 5 further includes, wherein a state of the switch is controlled by an enable signal of the component.

In Example 7, Example 6 further includes, wherein the switch, when closed, provides a clock of the component to the power balancing circuit and the power balancing circuit is off when the switch is open.

In Example 8, at least one of Examples 1-7 further includes, wherein the component is a first component and the power balancing circuit is a first power balancing circuit, the system further comprising a second component electrically connected to the conductor to receive power from the power supply, and a second power balancing circuit including a second bank of bleed circuits, the second power balancing circuit electrically connected to monitor a second electrical parameter of the power drawn by the second component and adjust a number of the bleed circuits drawing power from the power supply based on the second electrical parameter.

In Example 9, Example 8 further includes a second switch electrically connected between the power balancing circuit and the second component.

In Example 10, at least one of Examples 1-9 further includes, wherein the bank of bleed circuits comprise a ring oscillator.

In Example 11, at least one of Examples 1-10 further includes, wherein the component is driven by a first clock that operates at a lower frequency than a second clock that drives the power balancing circuit.

In Example 12, at least one of Examples 1-11 further includes, wherein the system includes multiple power delivery networks with corresponding power delivery boundaries, wherein the power balancing circuit is situated between a center of a footprint of the component and a nearest power delivery boundary of the power delivery boundaries.

In Example 13, Example 12 further includes, wherein the power balancing circuit is situated about halfway between the center of the footprint of the component and the nearest power delivery boundary of the power delivery boundaries.

Example 14 includes a power balancing circuit configured to protect a cryptography component from an observation attack, the power balancing circuit comprising a ring oscillator electrically connected to a power supply, a time-to-digital converter (TDC) electrically connected to monitor an electrical parameter of the electrical power drawn by the cryptography component and provide data indicative of the electrical parameter, and a controller circuit configured to adjust a number of inverters of the ring oscillator drawing power from the power supply based on the data.

In Example 15, Example 14 further includes, wherein operation of the power balancing circuit is controlled by a switch electrically connected between the power balancing circuit and the component.

In Example 16, Example 15 further includes, wherein a state of the switch is controlled by an enable signal of the component.

In Example 17, Example 16 further includes, wherein the switch, when closed, provides a clock of the component to the power balancing circuit and the power balancing circuit is off when the switch is open.

Example 18 includes a method for observation attack protection, the method comprising providing, by a conductor, electrical power from a power supply, receiving, by a component, the electrical power from the power supply, monitoring, by a power balancing circuit, an electrical parameter of the electrical power drawn by the component, and adjusting, by the power balancing circuit a number of inverters of the ring oscillator drawing power from the power supply based on the electrical parameter.

In Example 19, Example 18 further includes performing, by the component, cryptography operations.

In Example 20, at least one of Example 18-19 further includes providing, by a time-to-digital converter of the power balancing circuit, data indicative of a value of the electrical parameter.

In Example 21, Example 20 further includes receiving, at a controller circuit of the power balancing circuit, the data and setting, by the controller circuit, respective enable signals of the bleed circuits based on the data.

In Example 22, at least one of Examples 18-21 further includes disconnecting, by a switch electrically coupled between the power balancing circuit and the component, a clock that drives the component from the power balancing circuit.

In Example 23, at least one of Examples 18-22 further includes controlling, by an enable signal of the component, a state a state of a switch electrically coupled between the component and the power balancing circuit.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system for observation attack protection, the system comprising:
a conductor electrically coupled to a power supply;
a component electrically connected to the conductor to receive electrical power from the power supply; and
a power balancing circuit including a bank of bleed circuits, the power balancing circuit electrically connected to monitor an electrical parameter of the electrical power drawn by the component and adjust a number of the bleed circuits drawing power from the power supply based on the electrical parameter.

2. The system of claim 1, wherein the component is configured to perform cryptography operations.

3. The system of claim 1, wherein the power balancing circuit includes a time-to-digital converter configured to provide data indicating a change in the electrical parameter.

4. The system of claim 3, wherein the power balancing circuit includes a controller circuit configured to review the data and set respective enable signals of the bleed circuits based on the data.

5. The system of claim 1, further comprising a switch electrically connected between the power balancing circuit and the component.

6. The system of claim 5, wherein a state of the switch is controlled by an enable signal of the component.

7. The system of claim 6, wherein the switch, when closed, provides a clock of the component to the power balancing circuit and the power balancing circuit is off when the switch is open.

8. The system of claim 1, wherein the component is a first component and the power balancing circuit is a first power balancing circuit, the system further comprising:
a second component electrically connected to the conductor to receive power from the power supply; and
a second power balancing circuit including a second bank of bleed circuits, the second power balancing circuit electrically connected to monitor a second electrical parameter of the power drawn by the second component and adjust a number of the bleed circuits drawing power from the power supply based on the second electrical parameter.

9. The system of claim 8, further comprising a second switch electrically connected between the power balancing circuit and the second component.

10. The system of claim 1, wherein the bank of bleed circuits comprise a ring oscillator.

11. The system of claim 1, wherein the component is driven by a first clock that operates at a lower frequency than a second clock that drives the power balancing circuit.

12. The system of claim 1, wherein the system includes multiple power delivery networks with corresponding power delivery boundaries, wherein the power balancing circuit is situated between a center of a footprint of the component and a nearest power delivery boundary of the power delivery boundaries.

13. The system of claim 12, wherein the power balancing circuit is situated about halfway between the center of the footprint of the component and the nearest power delivery boundary of the power delivery boundaries.

14. A power balancing circuit configured to protect a cryptography component from an observation attack, the power balancing circuit comprising:
a ring oscillator electrically connected to a power supply;
a time-to-digital converter (TDC) electrically connected to monitor an electrical parameter of the electrical power drawn by the cryptography component and provide data indicative of the electrical parameter; and
a controller circuit configured to adjust a number of inverters of the ring oscillator drawing power from the power supply based on the data.

15. The power balancing circuit of claim 14, wherein operation of the power balancing circuit is controlled by a switch electrically connected between the power balancing circuit and the component.

16. The power balancing circuit of claim 15, wherein a state of the switch is controlled by an enable signal of the component.

17. The power balancing circuit of claim 16, wherein the switch, when closed, provides a clock of the component to the power balancing circuit and the power balancing circuit is off when the switch is open.

18. A method for observation attack protection, the method comprising:
providing, by a conductor, electrical power from a power supply;
receiving, by a component, the electrical power from the power supply;
monitoring, by a power balancing circuit, an electrical parameter of the electrical power drawn by the component; and
adjusting, by the power balancing circuit a number of inverters of the ring oscillator drawing power from the power supply based on the electrical parameter.

19. The method of claim 18, performing, by the component, cryptography operations.

20. The method of claim 18, further comprising providing, by a time-to-digital converter of the power balancing circuit, data indicative of a value of the electrical parameter.
